(19) United States
(12) Patent Application Publication
(10) Pub. No.: US 2007/0199578 A1
(43) Pub. Date: Aug. 30, 2007

(54) Cleaning apparatus, cleaning method and product manufacturing method

(75) Inventors: Michinao Nomura, Kawasaki (JP); Yoshiaki Yanagida, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/710,995

(22) Filed: Feb. 27, 2007

(30) Foreign Application Priority Data
Feb. 28, 2006 (JP) 2006-054065

(51) Int. Cl. B08B 3/12; B08B 7/00; B08B 3/00

(52) U.S. Cl. 134/1; 134/198; 134/157; 134/34; 134/33; 134/6

(57) ABSTRACT

A cleaning apparatus is provided with a plurality of cleaning mechanisms such as a blast unit, a vibration brush unit and a pulse spraying unit. Cleaning of objects with the blast unit and vibration brush unit is conducted within cleaning liquid reserved in a cleaning vessel in order to prevent electrostatic discharge (ESD) breakdown. Cleaning the objects with the pulse spraying unit is conducted after taking out the objects from the cleaning liquid and thereby re-adhesion of contamination remaining in the cleaning liquid to the objects is prevented.

### CROSS-REFERENCE TO RELATED APPLICATIONS

This application claims the benefit of Japanese Patent Application No. 2006-054065, filed Feb. 28, 2006, in the Japanese Intellectual Property Office, the disclosure of which is incorporated herein by reference.

### BACKGROUND OF THE INVENTION

1. Field of the Invention

The present invention relates to a cleaning method or a manufacturing method and a cleaning apparatus in the processing and manufacturing work of small-size objects (e.g., workpieces, devices or works).

2. Description of the Related Art

In recent years, small size devices of various kinds, for example, magnetic heads and MEMS (Micro Electro Mechanical Systems), have been used. Since these devices have fine structures, fine processes are required for the manufacturing and cleaning of such devices, in order to remove foreign matters and to prevent foreign matters, generated in the course of processing and manufacturing, that are left adhered to the manufactured devices, from damaging the device.

Here, a magnetic head will be explained as an example of devices to be manufactured. In the magnetic head processing steps, after a series of processes are performed, foreign matters (hereinafter, referred to as contamination) adhered to the surfaces of a plurality of magnetic heads arranged on a jig are removed using a multiple vessel type ultrasonic wave cleaning apparatus or a roller brush cleaning apparatus.

JP-A No. 1994-243784 and JP-A No. 2004-9174 disclose methods for cleaning works with high-pressure water flow including polishing particles. Moreover, JP-A No. 1989-105376 and JP-A No. 1992-189548 disclose cleaning methods for spraying cleaning liquid to works by applying ultrasonic waves to the cleaning liquid.

However, the cleaning methods of the related arts encounter difficulty in effective cleaning of contamination adhered to devices because of circumstances, such as improvement in micro-miniaturization of devices. For example, contamination by wax and residue of resists may be adhered on the magnetic head during the processing steps thereof, but it is very difficult to perfectly remove such contamination in sub-micron order with the cleaning methods of the related arts.

Moreover, several surfaces are formed on magnetic heads. Here, a problem rises in that cleaning effects at respective surfaces are different to a large extent even when the completely identical cleaning method is employed for cleaning of the magnetic heads. For example, in the case where the roller brush cleaning method is employed, a degree of cleaning and remaining contamination is different in larger possibility for each surface of the magnetic head in accordance with contact state to the roller brush. This influence increases as the device progresses in its fine structure.

In the cleaning methods described in the patent document JP-A No. 1994-243784 and JP-A No. 2004-91, polishing particles are injected to works. In the cleaning methods described in these patent documents, possibility of giving damages to the work is considerably high because the polishing particle collides with the work in higher velocity.

Moreover, in the cleaning method described JP-A No. 1989-105376 and JP-A No. 1992-189548, damages to the work are rather small in amount because the polishing particle is never blown to the work. However, another problem is also generated, in that cleaning effect is good at the surface to which the cleaning liquid is sprayed, while very poor at other surfaces of the work. Moreover, electrostatic discharge (ESD) breakdown is likely to occur on the work depending on the cleaning condition.

### SUMMARY OF THE INVENTION

Additional aspects and/or advantages of the invention will be set forth in part in the description which follows and, in part, will be apparent from the description, or may be learned by practice of the invention.

Considering the problems to be solved, an object of the present invention is to provide a cleaning method, manufacturing method and a cleaning apparatus for improving efficiency of removing contamination.

Moreover, another object of the present invention is to provide a cleaning method, manufacturing method and a cleaning apparatus for realizing effective cleaning while reducing damages to works.

Moreover, another object of the present invention is to provide a cleaning method, manufacturing method and a cleaning apparatus for uniformly removing contamination on the work.

In order to solve the problems explained above, the present invention is characterized in providing a cleaning apparatus comprising a cleaning vessel reserving liquid and a spraying unit spraying cleaning liquid, including a polishing particle, to operate in the manner that said cleaning objects is located in the liquid reserved in said cleaning vessel during the cleaning of said cleaning objects and the cleaning liquid is sprayed to said cleaning objects from said spraying unit within said liquid.

Moreover, the present invention is characterized in providing a cleaning apparatus comprising a cleaning vessel reserving liquid and a brushing unit brushing said cleaning objects to operate in a manner that said cleaning objects is located within the liquid reserved in said cleaning vessel during the cleaning of said cleaning objects and said cleaning objects are brushed with said brushing unit within said liquid.

Moreover, the present invention is characterized in providing a cleaning apparatus comprising a single cleaning vessel reserving therein cleaning liquid, a holding mechanism moving a cleaning object into said cleaning vessel, a first cleaning mechanism executing a first cleaning requiring mechanical contact with said cleaning objects, and a second cleaning mechanism executing a second cleaning by spraying the cleaning liquid to said cleaning object, to operate in the manner that the cleaning of said cleaning object is conducted with said second cleaning mechanism outside of said cleaning vessel after the cleaning of said cleaning objects with said first cleaning mechanism within said cleaning vessel.

Moreover, the present invention is characterized in providing a product manufacturing method comprising a pre-process conducting processing to processing objects, a process of moving the processing objects into a cleaning vessel reserving cleaning liquid, a process of spraying the cleaning liquid including the polishing particle to the processing objects within the cleaning liquid, a process of taking out the processing objects from the cleaning liquid, and a post-process of conducting processing to the processing objects having completed the cleaning process. Any kind of pre-process or post-process may be conducted. Moreover, since the pre-process or post-process may not be conducted with a certain possibility in accordance with the product manufacturing process, only the pre-process or post-process can also be conducted, as required, in combination with the cleaning process.

Similarly, the present invention is characterized in providing a product manufacturing method comprising conducting pre-processing to processing objects, moving the processing objects into a cleaning vessel reserving cleaning liquid, brushing the processing objects using a brush within the cleaning liquid, taking out the processing objects from the cleaning liquid, and conducting post-processing to the processing objects, having completed the cleaning process.

Moreover, the present invention is characterized in providing a product manufacturing method comprising a pre-process for conducting processing steps to a processing objects, a process for cleaning the processing objects within cleaning liquid, a process for taking out the processing objects from the cleaning liquid, a process for spraying the cleaning liquid to the processing objects, and a post-process for conducting processing steps to the processing objects.

Meanwhile, the present invention is characterized in providing a cleaning method comprising locating a cleaning objects within cleaning liquid,

spraying a polishing particle to the cleaning objects within the cleaning liquid, brushing the cleaning objects within the cleaning liquid after the polishing particle spraying, taking out the brushed cleaning objects from the cleaning liquid, and spraying the cleaning liquid to the cleaning objects taken out from the cleaning liquid.

Moreover, the present invention is characterized in providing a product manufacturing method comprising soaking the processing objects in cleaning liquid, and cleaning the processing objects with the cleaning method, requiring mechanical contact to the processing objects within the cleaning liquid.

Moreover, the present invention is characterized in providing a product manufacturing method comprising soaking the processing objects in cleaning liquid, cleaning the processing objects with a first cleaning method within the cleaning liquid, taking out the processing objects from the cleaning liquid, and cleaning the processing objects with a second cleaning method, different from the first cleaning method.

Moreover, the present invention is characterized in providing a cleaning apparatus comprising a mechanism for moving the cleaning objects, a first cleaning mechanism for spraying cleaning liquid including a polishing particle to the cleaning objects within the cleaning liquid, a second cleaning mechanism for brushing the cleaning objects within the cleaning liquid, a third cleaning mechanism for spraying the cleaning liquid to the cleaning objects outside of the cleaning liquid, wherein the cleaning apparatus operates to conduct cleaning of the cleaning objects in the sequence of cleaning by the first cleaning mechanism, the second cleaning mechanism, and the third cleaning mechanism.

The present invention can realize effective cleaning of cleaning objects and also can reduce damage on the cleaning objects which likely occurs during the cleaning process.

### BRIEF DESCRIPTION OF THE DRAWINGS

The above features These and/or other aspects and advantages of the invention will become apparent and more readily appreciated from the following description of the embodiments taken in conjunction with the accompanying drawings in which:

FIG. 1 is an external front view of a cleaning apparatus as an embodiment of the present invention.

FIG. 2 is an external front view of an external circulating unit based on an embodiment of the present invention.

FIG. 3 is an external perspective view of the cleaning apparatus based on an embodiment of the present invention.

FIG. 4 is an enlarged view of the essential part of the cleaning apparatus based on an embodiment of the present invention.

FIG. 5 is a diagram showing an example of works to be cleaned with the cleaning apparatus based on an embodiment of the present invention.

FIG. 6 is a top view of the cleaning apparatus based on an embodiment of the present invention.

FIG. 7 is a diagram showing a blast unit based on an embodiment of the present invention.

FIGS. 8(a) and 8(b) are diagrams showing a rotating profile and cleaning operation of the blast unit based on an embodiment of the present invention.

FIGS. 9(a), 9(b), 9(c) and 9(d) are diagrams showing a vibration brush unit and the cleaning operations with the vibration brush unit based on an embodiment of the present invention.

FIG. 10 is a diagram showing a pulse spraying unit based on an embodiment of the present invention.

FIG. 11 is a schematic diagram of a cleaning liquid circulating mechanism of the cleaning apparatus based on an embodiment of the present invention.

FIG. 12 is a flowchart showing the procedures of the cleaning of works using the cleaning apparatus based on an embodiment of the present invention.

FIG. 13 is a flowchart showing the procedures of the blast cleaning based on an embodiment of the present invention.

FIG. 14 is a flowchart showing the cleaning procedures of the sound wave brush cleaning based on an embodiment of the present invention.

FIG. 15 is a flowchart showing the pulse spray cleaning procedures based on an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

A cleaning apparatus according to a preferred embodiment of the present invention will be explained with reference to the accompanying drawings. The cleaning processes using the cleaning apparatus of the present invention is assumed to be conducted as a part of a manufacturing processes of an object to be manufactured or processed. In the case of the magnetic head manufacturing processes, for example, the cleaning of such magnetic heads with the cleaning apparatus of these embodiments may be conducted between the processing of the magnetic head itself (including cutting and polishing, or the like) and assembling the magnetic head into a magnetic disk drive (mounting of the magnetic head to a suspension, or the like). The cleaning apparatus of these embodiments is not necessarily required to be a part of the manufacturing processes of a product, and a part of the manufacturing process for executing the cleaning process is not restricted to the example explained above. Moreover, a product to be cleaned is not restricted to a magnetic head.

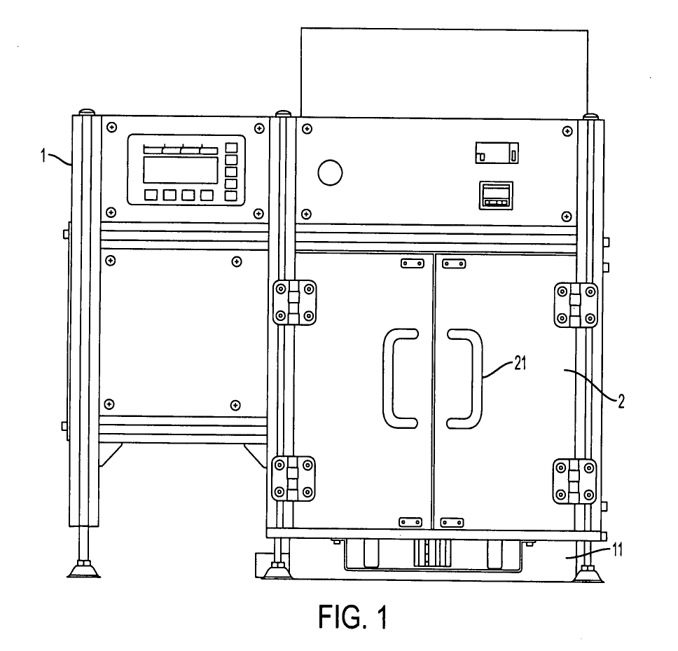

FIG. 1 is an external front view of a cleaning apparatus 1 of the present embodiment. The cleaning apparatus 1 of the embodiment is formed in the width of 700 mm, depth of 550 mm, and height of 500 mm, for example. Therefore, this cleaning apparatus can be set on a desk. A door 2 is provided at the front of the cleaning apparatus 1 and can be opened or closed by holding a grip 21. The state of works in the cleaning apparatus 1 may be verified by using the transparent (or semi-transparent) door 2.

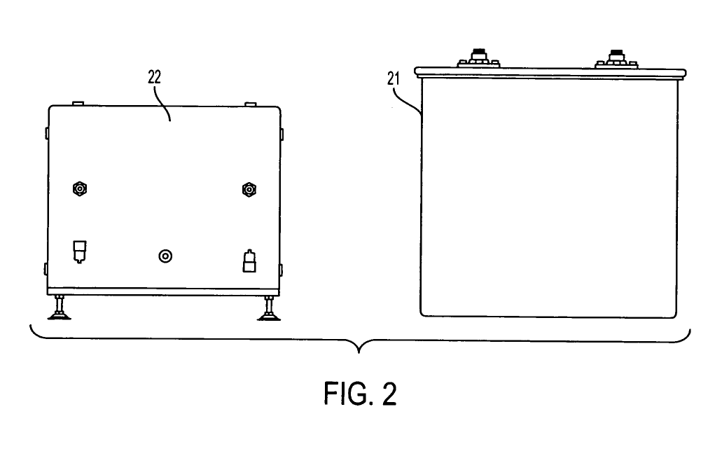

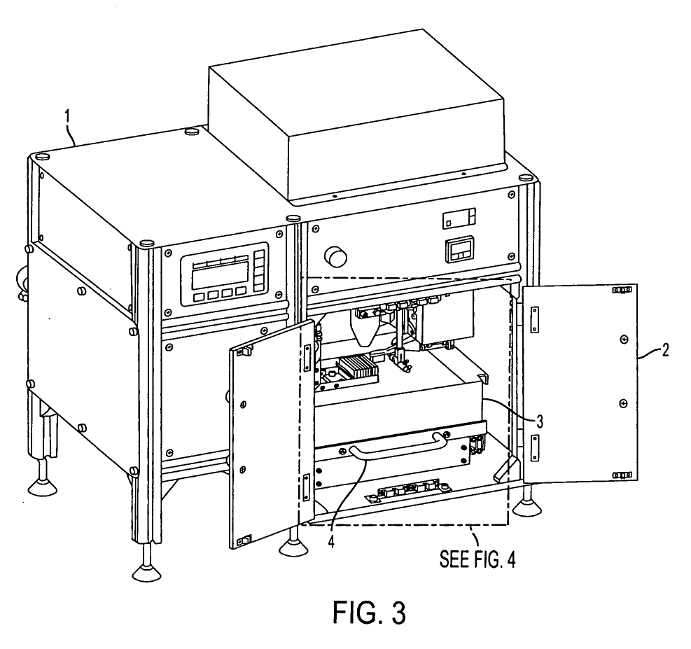

At the rear side of the cleaning apparatus 1 illustrated in FIG. 1, a temporary tank 11 connected to a cleaning vessel 3 (See FIG. 3) with piping is also provided. The temporary tank 11 is provided to temporarily reserve cleaning liquid for collecting and circulating the cleaning liquid within the cleaning vessel 3. Moreover, the temporary tank 11 is connected to a cleaning liquid tank 21, illustrated in FIG. 2, with the piping. The cleaning liquid reserved in the cleaning liquid tank 21 is supplied again to the cleaning vessel 3 with an external circulation unit 22 provided with a pump or the like.

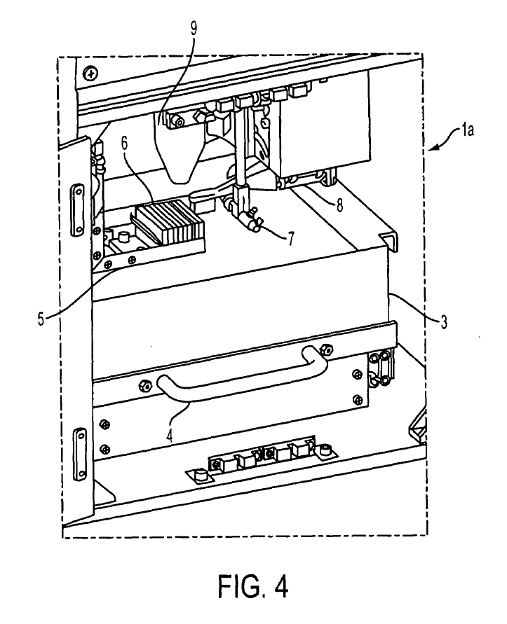

FIG. 3 is a external-perspective view of the cleaning apparatus 1 with the door 2 opened. Moreover, FIG. 4 is a diagram showing the expanded essential portion (the part surrounded with a rectangular (a) in FIG. 3) of the cleaning apparatus 1, illustrated in FIG. 3.

Cleaning area 1a (See FIG. 4) is where a mechanism for cleaning works, for example, is arranged. Within the cleaning area 1a, the cleaning vessel 3 is provided. At the front of the cleaning vessel 3, a grip 4 is provided. Both ends of the cleaning vessel 3 are supported with a slide rail and therefore the cleaning vessel 3 can be pulled forward to the external side of the cleaning area 1a by holding and manipulating the grip 4.

During the cleaning of works, the cleaning liquid is stored within the cleaning vessel 3. The cleaning liquid used here is, for example, pure water but solvents, such as an organic solvent other than the pure water, can also be used as required.

In the cleaning area 1a, a plurality of cleaning mechanisms is allocated. The cleaning apparatus 1 of this embodiment is provided with a blast unit 7, a vibration brush unit 8, and a pulse spraying unit 9, as the cleaning mechanisms. The blast unit 7 executes cleaning of the work surface by spraying the cleaning liquid including a polishing particle from the front end thereof. The vibration brush unit 8 removes contamination adhered to the works 6 by brushing the works 6. The pulse spraying unit 9 removes contamination on the works by spraying the cleaning liquid to which an ultrasonic wave is impressed.

Details of each cleaning mechanism will be explained later. The cleaning apparatus 1 of this embodiment is capable of selectively using, as required, a plurality of cleaning mechanisms or methods to enable cleaning of works by preventing damage, including ESD breakdown, to the works as the cleaning objects and to realize more effective cleaning. According to an embodiment of the present invention, the cleaning apparatus 1 of the present embodiment conducts cleaning of the works 6 in the sequence of the blast cleaning utilizing the blast unit 7, brushing using the vibration brushing unit 8, and pulse spray cleaning using the pulse spraying unit 9. However, the cleaning mechanism used for the work cleaning and the cleaning sequence thereof may be different from the sequence explained above.

In the cleaning area 1a, a fixing unit 5 for fixing the works 6 as the cleaning objects is also provided. The fixing unit can be moved to swing in the vertical direction, forward and backward direction, and right and left direction with a mechanism provided on the side of the cleaning apparatus 1 (arranged within the cover, not illustrated in FIGS. 1, 3, and 4).

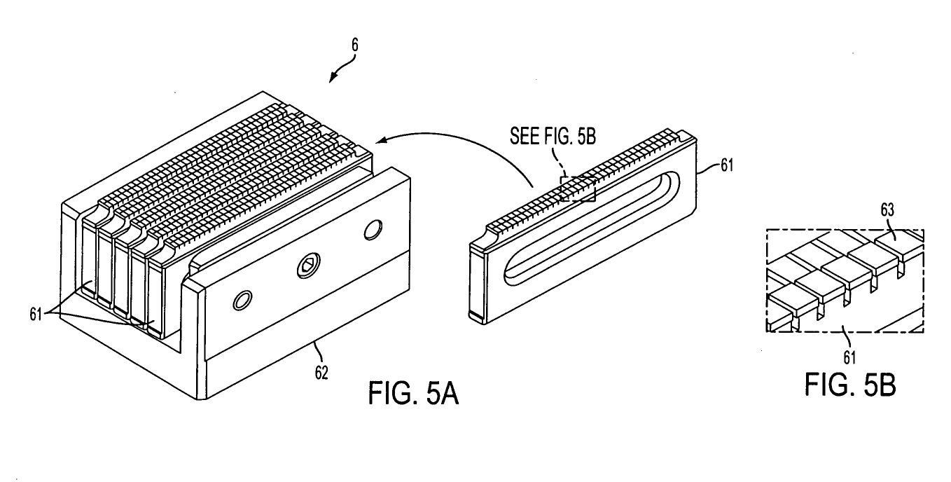

FIG. 5 is a diagram showing an example of the works 6 as the cleaning objects of the cleaning apparatus 1 of the present embodiment. Here, a magnetic head is illustrated as the cleaning works.

As illustrated in FIG. 5, a plurality of magnetic heads 63 which have been cut away from a wafer and have completed other processes (polishing or the like) are adhered to an upper end of a tool 61. The tool 61 to which the magnetic heads 63 are adhered is set to a holder 62 for cleaning of the magnetic heads 63. A plurality of tools 61 may be set to the holder 62. The holder 62 to which the tools 61 are set is set to the fixing unit 5 shown in FIG. 4 and thereafter the magnetic heads 63 on the tool 61 are cleaned with the cleaning apparatus 1.

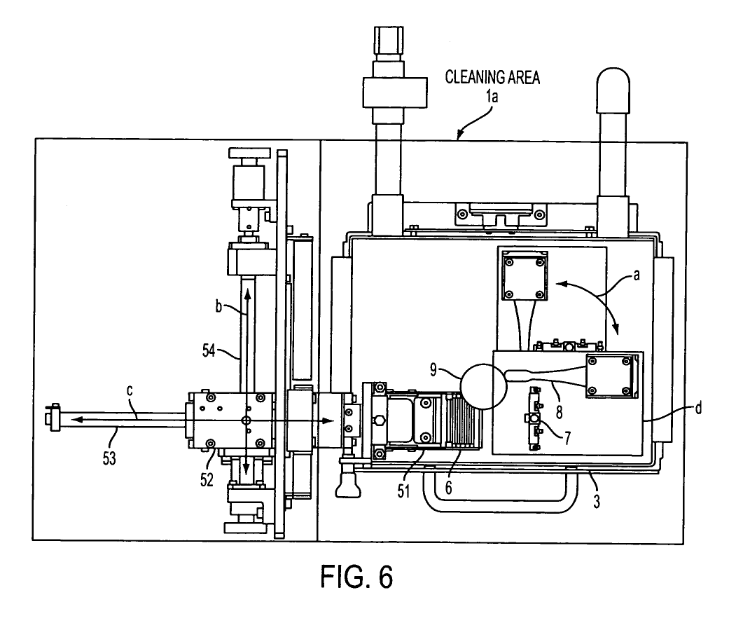

FIG. 6 is a diagram illustrating the cleaning apparatus 1 of the embodiment viewed from the upper side. The fixing unit 51, to which the works 6 are set, is mounted to a swinging mechanism 52 provided at the base area thereof. The swinging mechanism 52 is swung, along the rail 52 and rail 54, in the forward and backward direction (b) and right and left direction (c) viewed from the front surface of the cleaning apparatus 1. Moreover, the swinging mechanism 52 can also be swung in the vertical direction viewed from the front surface of the cleaning apparatus 1. Accordingly, the works 6 can be positioned within the cleaning vessel 3 through movement thereof within the cleaning area 1a.

Moreover, in the cleaning apparatus 1 of the present embodiment, the blast unit 7 and vibration brush unit 8 can be revolved, with a revolving mechanism (schematically illustrated as (d) in the figure), around the works 6 within the range of 0° to 90° in the arrow mark direction (a). Although details will be explained later, the works 6 can be cleaned from various directions by varying the locations of the blast unit 7 and vibration brush unit 8 and by adjusting as required the spraying angle and/or direction of the cleaning liquid from the blast unit 7 and the brushing direction of works with the vibration brush unit 8. Here, revolving range by the revolving mechanism is not limited to the range explained above and it is not essential that the blast unit 7 and vibration brush unit 8 are revolved together.

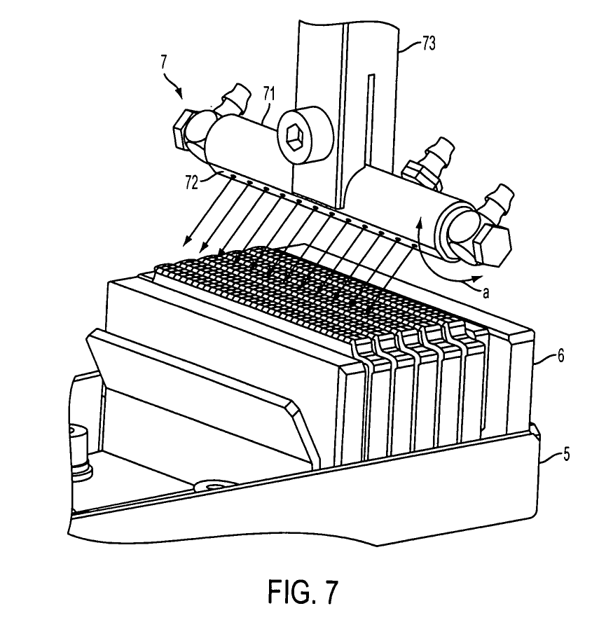

FIG. 7 is a diagram illustrating the expanded essential portion of the blast unit 7 of the present embodiment. At the front end of the blast unit 7 of the present embodiment, an almost cylindrical shape nozzle 71 is provided. The nozzle 7 is provided with a plurality of nozzle apertures 72 formed along the longitudinal direction thereof and therefore the cleaning liquid is sprayed toward the works 6 from the nozzle apertures 72 (linear arrows shown in FIG. 7). It is preferred that the diameter of nozzle apertures 72 is 1.0 mm or less.

The nozzle 71 can rotate in the direction of arrow mark (a) to the base area 73 with operations of a rotating mechanism not illustrated. Rotating range of nozzle 71 is 0° to 90° in the present embodiment. The spraying angle of the cleaning liquid relative to the cleaning surface of the work 6 can be adjusted in the range of 0° to 90° by changing as required the angle of nozzle 71 to the base area 73 during the cleaning process of the works 6, and thereby the cleaning liquid can be sprayed to the works 6 from various directions.

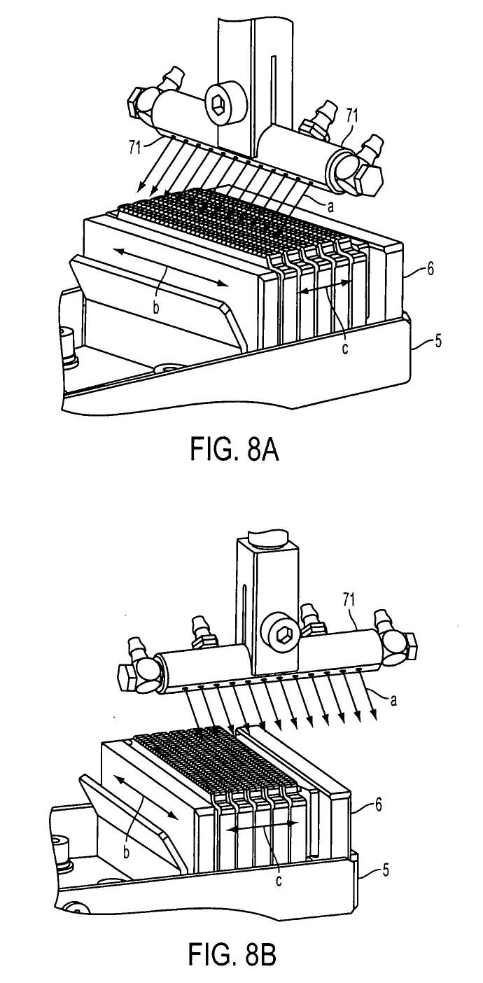

Moreover, a location of the nozzle 71 can be changed within the range of 90 degrees along the horizontal plane. FIG. 8 (a) and FIG. 8 (b) are diagrams for explaining movement of the nozzle 71 in the direction of the horizontal plane. FIG. 8(a) shows the state where the longitudinal direction of the works 6 is matched with that of the nozzle 71. Moreover, FIG. 8(b) shows the state where the longitudinal direction of the nozzle 71 is rotated 90° to that of the works 6.

As explained above, the cleaning liquid can be sprayed to the works 6 in various directions by changing the orientation of the nozzle 71 and thereby more effective cleaning of works can be expected.

Cleaning of the works 6 with the blast unit 7 of the present embodiment will be conducted in the procedures explained below.

The cleaning liquid sprayed from the blast unit 7 includes a polishing particle. Contamination adhered on the works 6 is cleaned by spraying, with high velocity, the cleaning liquid including the polishing particle to the works 6 from the nozzle apertures 72. Here, when the polishing particle is in contact with the works 6, the works 6 are likely to be damaged mechanically. Influence of damage on the works 6 becomes very large when the work 6 becomes fine. Accordingly, in view of preventing damage on the works 6 due to the polishing particle, the works 6 are soaked, during the cleaning process of works 6, into the cleaning liquid reserved in the cleaning vessel 3 and the cleaning liquid is sprayed to the work 6 from the nozzle apertures 72 within the cleaning liquid reserved in the cleaning vessel 3. Here, since the blast cleaning of works 6 is not conducted in the air, generation of static electricity during the cleaning of works 6 can be controlled and ESD breakdown during the cleaning of works can also be prevented.

During the cleaning of works 6, the cleaning liquid (a) is sprayed to the works 6 from the nozzle apertures 72 in the state of FIG. 8(a). In this case, location of the works 6 is adjusted so that an interval between the works 6 and nozzle apertures 72 becomes about 10 mm.

While the cleaning liquid (a) is sprayed, the swinging mechanism 52 is driven to swing the works 6 in the direction indicated with the arrow marks (b). The works 6 are reciprocally moved at the rate of several millimeters per second to realize the blast cleaning process using the blast unit 7. Moreover, while the works 6 are moved in the direction of the arrow marks (c), the blast cleaning is conducted. Thereby, the cleaning liquid (a) can be sprayed uniformly to the works 6.

In the state of FIG. 8(a), the angle of the nozzle 71 can be varied, as required, during the cleaning of works 6, or the angle of the nozzle 71 can be fixed to a particular angle on the occasion of cleaning the works 6. Angle of the nozzle 71 and drive of nozzle 71 can be selected adequately in accordance with a kind of the work as the cleaning objects and the kind of cleaning process.

Subsequently, as illustrated in FIG. 8(b), the cleaning liquid (a) is sprayed to the works 6 by rotating the nozzle 7 90° from the state illustrated in FIG. 8(a). Even in the state of FIG. 8(b), cleaning of the works 6 is conducted by swinging the works 6 in the directions of the arrow mark b and/or in the direction of the arrow mark c.

Comparatively large contamination adhered to the surfaces of works 6 can be removed and the binding force of contamination can also be lowered with the polishing particle included in the cleaning liquid through the blast cleaning process. Moreover, various damages to the works 6 can be prevented by conducting the blast cleaning within the cleaning liquid.

With the spraying of the cleaning liquid (a) to the works 6 from multiple directions, the cleaning liquid (a) can be sprayed to each surface forming the work 6 and, thereby, more effective cleaning of works can be realized.

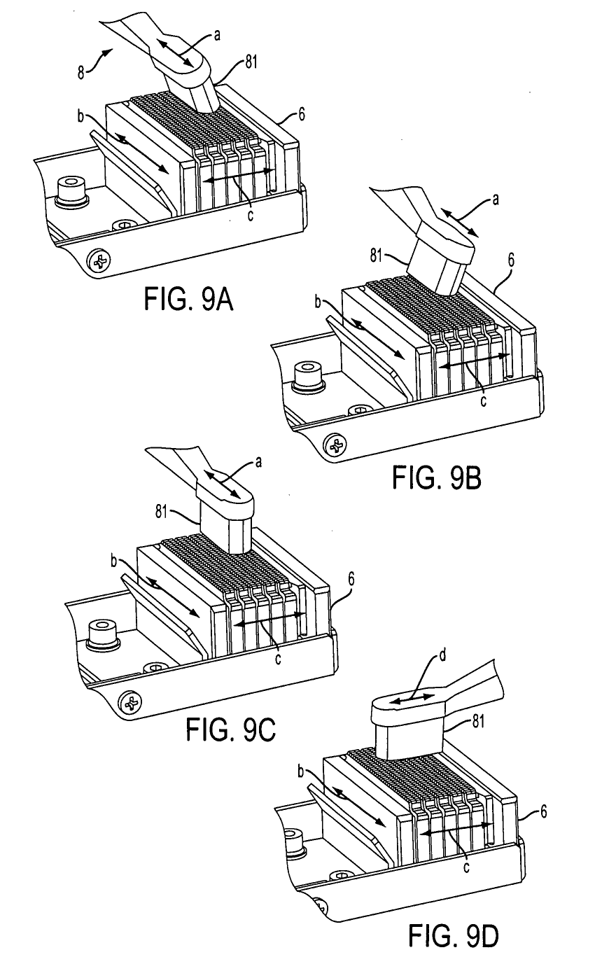

FIGS. 9(a) to 9(d) are diagrams illustrating the enlarged essential portion of the vibration brush unit 8 of the present embodiment and explaining operations of the vibration brush unit 8 during the cleaning of works 6. The vibration brush unit 8 will be explained in combination with FIG. 4.

The vibration brush unit 8 of the present embodiment is controlled to generate sound wave vibration to conduct sound wave vibration brush cleaning of the works 6. The front end of the vibration brush unit 8 is provided with a soft brush 81 with a narrow brush diameter. The soft brush 81 can vibrate in the frequency of about several hundreds hertz and in the amplitude of about 1 mm. This vibration realizes the brushing of works 6.

FIG. 9(a) shows the cleaning operation of the works 6 with the vibration brush unit 8 in the first state. The soft brush 81 is driven in the direction of the arrow marks (a) in separation from the sound vibration explained above. Accordingly, brushing is conducted to the surfaces of works 6. Therefore, the works 6 are brushed through combination of the sound vibration of the soft brush 81 and movement in the direction of the arrow mark (c).

Meanwhile, during the cleaning process of works 6, the works 6 are reciprocally moved in the direction of the arrow mark b in combination with vibration of the soft brush 81. Swinging velocity of the works during the brushing is for example 80 mm/sec and the number of times of swinging can be set to multiple times. Moreover, the works 6 are sent in a certain pitch in the direction of the arrow mark c and the surfaces of works 6 to which the soft brush 81 is applied is changed, as needed.

The soft brush 81 can be changed in its angle to the axial direction in the range of +30°, 0°, and −30°. FIG. 9(a) shows the state where the soft brush 81 is fallen by 30° for the works 6.

FIG. 9(b) shows the state where the soft brush 81 is fallen in the direction opposed to that in FIG. 9(a). Moreover, FIG. 9(c) shows the state (=0) where the soft brush 81 is located in the vertical direction to the surfaces of works 6. As explained above, brushing of the works 6 can be conducted from various directions and fluctuation in the cleaning effect depending on the surface can also be controlled by switching the angle of the soft brush 81, with respect to the surfaces of works 6.

Moreover, as explained above, the vibration brush unit 8 can be rotated on the horizontal plane to the work surface within the range of 0° to 90°. FIG. 9(d) shows the state where the soft brush 81 is rotated by 90° from the state of FIG. 8(c). The soft brush 81 can be inclined in the range of +/−30° to the axial direction in the state illustrated in FIG. 9(d).

In the state of FIG. 9(d), the soft brush 81 is in the direction indicated with the arrow mark d. In accordance with change in the swinging direction of the soft brush 81, the works 6 are swung in the direction of arrow mark c and sent in a certain pitch in the direction of the arrow mark b.

In FIG. 9(a) to 9(c), the soft brush 81 swings in the direction along the longitudinal direction of the tool 62. For the effective brushing of gaps among a plurality of tools 62, the angle of the soft brush 81 is switched in the range of +30°, 0, and −30° in the examples of FIG. 9(a) to 9(c). Meanwhile, in the state of FIG. 9(d), the soft brush 81 swings in the direction crossing in orthogonal the direction where gap between the tools 62 is extending. During the brushing in this direction, the soft brush 81 is set to the angle only of 0°.

As explained above, contamination adhered to each surfaces of the works 6 can be effectively removed through combination of the sound vibration of the soft brush 81 and brushing using the soft brush 81. Moreover, even if contamination adhered to the works 6 cannot be removed perfectly, binding force of contamination can be lowered by conducting the brushing cleaning. Contamination that is lowered in its binding force can be removed easily with the subsequent cleaning process.

Moreover, the polishing particle is used in the blast cleaning explained above, and the polishing particle is likely adhered to the works 6. Therefore, the polishing particle remaining on the works 6 can be removed with the vibration brush unit 8 by conducting the sound wave brush cleaning after the blast cleaning.

In view of preventing damages of the works 6 due to the brushing, brushing of the works 6 is conducted within the cleaning liquid reserved in the cleaning vessel 3 in the cleaning apparatus of the present embodiment. Moreover, since the brushing is not conducted in the air but in the cleaning liquid, prevention of ESD breakdown of the works 6 is expected. Moreover, to reduce the possibility for ESD breakdown, it is preferable to use a conductive resin for the soft brush 81.

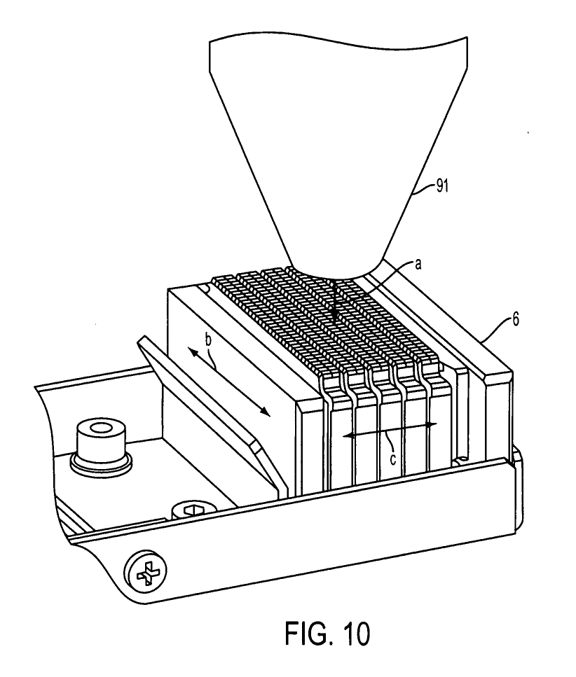

FIG. 10 is a diagram for explaining operations of the pulse spray cleaning using the pulse spraying unit 9. The cleaning liquid (a) to which the ultrasonic is applied is sprayed from the nozzle apertures 91 provided at the front end of the pulse spraying unit 9. Distance between the nozzle apertures 91 and the surfaces of works 6 during the pulse spray cleaning is, for example, about 10 mm. When the cleaning liquid is sprayed from the nozzle apertures 91, the works 6 are swung in the direction of the arrow mark b so that the cleaning liquid is uniformly sprayed to the entire part of the works 6. The swinging velocity of the works during the pulse spray cleaning is several mm/s and the number of times of swinging is, for example, one. Moreover, the works 6 are also sent with a certain pitch in the direction of the arrow mark c.

The ultrasonic wave with a frequency of about 1 MHz is applied to the cleaning liquid sprayed from the nozzle apertures 91. Moreover, the cleaning liquid is preferably sprayed from the nozzle apertures 91 in the rate of one litter per minute or less. With application of ultrasonic wave to the cleaning liquid, vibration of the cleaning liquid is generated in the molecular level and contamination of sub-micron order adhered to the works 6 can be removed and moreover contamination which is lowered in the binding force with the blast cleaning or sound wave vibration brush cleaning can also be removed.

The cleaning apparatus 1 of the present embodiment can remove foreign matters using a filter by collecting the cleaning liquid within the cleaning vessel 3. However, contamination removed from the works 6 during the blast cleaning or sound wave vibration brush cleaning is likely floating in the cleaning liquid reserved in the cleaning vessel 3. When the pulse spray cleaning is conducted in the cleaning liquid, contamination floating in the cleaning liquid is likely to be adhered again to the works. Here, a possibility of damaging the works is assumed to be rather low and a possibility for ESD breakdown due to static electricity is also assumed to be low because no mechanical contact between the works and the other members (polishing particle, brush or the like) is assumed, unlike the blast cleaning or sound wave vibration brush cleaning. Accordingly, during the pulse spray cleaning of the present embodiment, the works 6 are taken out from the cleaning vessel 3 and the cleaning liquid is sprayed to the works outside of the cleaning vessel 3. Thereby, possibility for re-adhesion to the works of contamination floating in the cleaning liquid can be lowered.

In the present embodiment, the pulse spray cleaning can be considered as the final cleaning of the cleaning processes of works 6.

Here, since inconvenience is likely to occur if the cleaning liquid is left on the works 6, it is desirable to additionally provide a function to blow away the cleaning liquid using an air blower or the like to the cleaning apparatus 1.

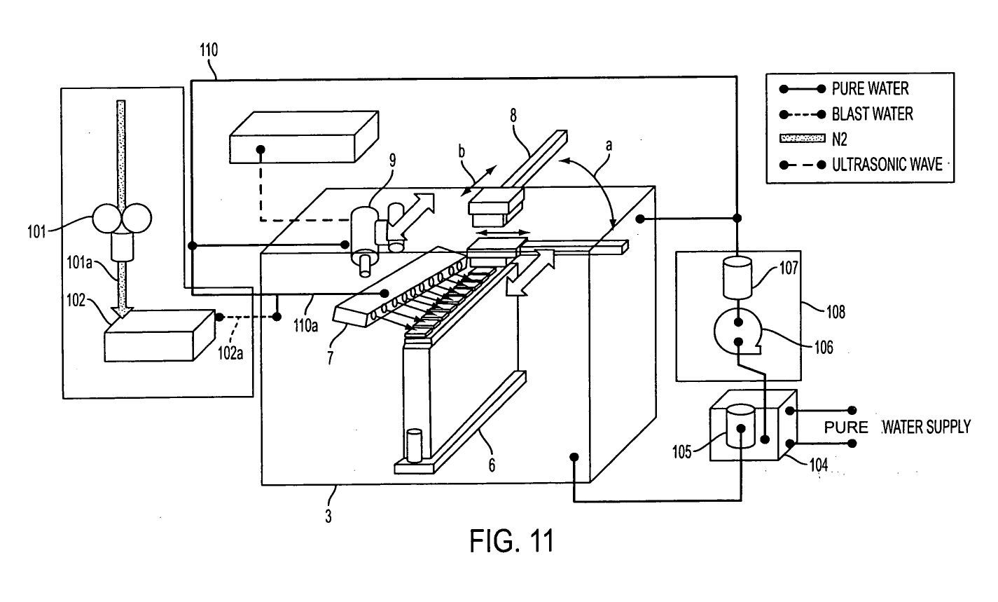

FIG. 11 is a diagram schematically showing the mechanism in relation to the cleaning liquid circulating system and cleaning liquid of the cleaning apparatus 1 of the present embodiment.

As explained above, when the works are cleaned, the cleaning liquid is likely to be polluted because of adhesion of contamination to the cleaning liquid reserved within the cleaning vessel 3. Therefore, the cleaning apparatus 1 of this embodiment circulates the cleaning liquid in order to remove various causes of pollution in the course of circulation of the cleaning liquid.

As explained above, the cleaning liquid (pure water) is reserved in the cleaning vessel 3. The cleaning apparatus 1 is connected with a pure water tank 104 to reserve the pure water and this pure water tank 104 is provided with a filter 105 for filtering contamination floating in the cleaning liquid. Moreover, the cleaning liquid is circulated within the cleaning apparatus 1 via a cleaning liquid circulating unit 108 (provided with a filter 107 and a pure water pump 106) connected to the pure water pump 104. As the filter in the pure water pump 106, a filter having the filtering accuracy in the order of several microns is used and a filter having a sub-micron filtering accuracy is provided in the cleaning apparatus.

The pure water pump 106 is connected with the blast nozzle/blast unit 7 and the pulse spray nozzle 9 via the piping 110. The pulse spray nozzle 9 can swing in the direction indicated with a thick hollow arrow mark. Since nozzle 9 can spray the cleaning liquid (pure water), the piping for supplying the cleaning liquid is connected to the blast nozzle 7 and pulse spray nozzle 9.

The piping connected to the blast nozzle 7 is connected with a piping 102a extended from the tank 102 for blasting. The blast tank 102 reserves the polishing particle mixed with the cleaning liquid sprayed from the blast unit 7 and the polishing particle is supplied to the blast unit 7 with the nitrogen gas supplied via a regulator 101 for adjusting nitrogen and a piping 101a. The polishing particle supplied is mixed with the cleaning liquid within a piping 110a.

On the other hand, the pulse spray nozzle 9 is connected with an ultrasonic wave oscillator 103 for generating the ultrasonic wave to be applied to the cleaning liquid.

The cleaning liquid is circulating in the cleaning apparatus 1 and the cleaning liquid over flowing from the cleaning vessel 3 during the cleaning process is collected by the cleaning liquid tank 104 via the temporary tank 11 provided at the rear surface of the cleaning apparatus 1. The cleaning liquid collected into the inside of the cleaning liquid tank 104 is supplied again to the cleaning apparatus 1 with an external circulating unit/cleaning liquid circulating unit 108.

The polishing particle used for the blast cleaning is separated from the cleaning liquid within the cleaning vessel 3 and temporary tank 11 and is then collected in separation from the cleaning liquid. For collection of the polishing particle, a filter, for example, is used.

Moreover, a profile (a) in rotation of the brush unit in FIG. 11 and a profile (b) in swing thereof are schematically illustrated.

In this embodiment, the pure water is used as the cleaning liquid, but the other solvents may also be used as the cleaning liquid. Therefore, as the components and pipes for liquid provided within the cleaning area 1a, conductive or charge-free materials having excellent anti-corrosion property such as stainless, conductive polyether ether ketone resin (PEEK), charge-free fluorine resin may be used. Particularly, the effect of preventing ESD breakdown of the works can be attained by using the conductive or charge-free materials.

As the solvents used as the cleaning liquid, organic solvents such as IPA may be used. When such an organic solvent has been used as the cleaning liquid, it is desirable to absorb and exhaust the air from a duct connecting port provided at the rear surface of the cleaning apparatus 1.

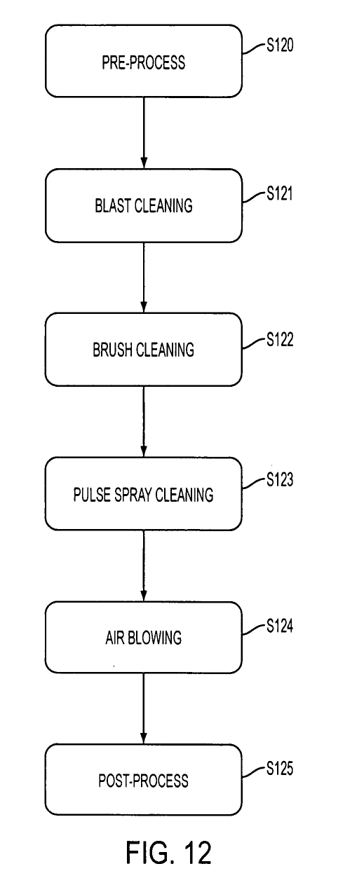

FIG. 12 is a flowchart for explaining the manufacturing and cleaning procedures of the works using the cleaning apparatus of the present embodiment.

In this embodiment, after the works having completed the pre-process (S120) are set, they are subjected to the blast cleaning (S121), thereafter the sound wave vibration brush cleaning (S122), and the pulse spray cleaning (S123). Following the pulse cleaning, the cleaning liquid is removed (S124) from the works with the air blowing, for example. Thereafter, the post-process is conducted (S122) to the works.

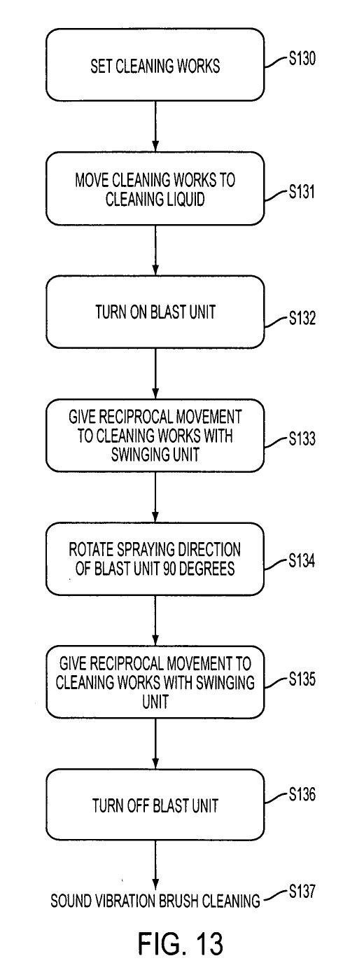

FIG. 13 is a flowchart showing procedures of the blast cleaning in the present embodiment.

On the occasion of conducting the blast cleaning, the works 6 are set first to the fixing unit 5 within the cleaning apparatus 1 (S130). Thereafter, the swinging mechanism 52 is driven to move the works 6 into the cleaning liquid reserved in the cleaning vessel 1 (S131). Subsequently, the blast unit 7 is moved into the cleaning liquid to position the blast unit 7 and the works 6. Thereafter, the blast unit 7 is turned ON to start spraying of the cleaning liquid (S132). Simultaneously, the swinging mechanism 52 is operated to reciprocally move the works 6 (S133).

After completion of the predetermined cleaning operations, the blast unit 7 is rotated to rotate the spraying direction of cleaning liquid 90° (S134). Thereafter, the works 6 are moved reciprocally in conjunction with the spraying of the cleaning liquid from the blast unit 7 (S135). After completion of the predetermined cleaning operation, spraying of the cleaning liquid from the blast unit 7 is stopped (S136) to complete the blast cleaning process and the cleaning process shifts to the sound wave brush cleaning (S137).

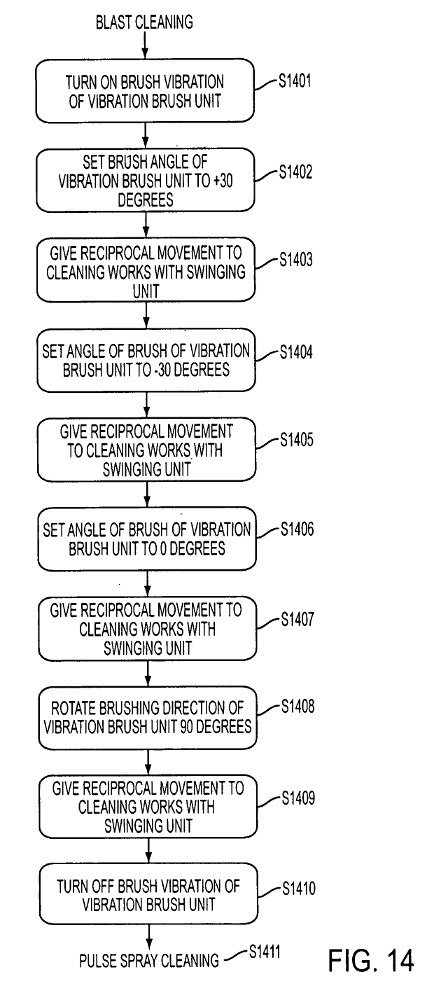

FIG. 14 is a flowchart showing procedures of the sound wave brush cleaning of the present embodiment.

The sound wave brush cleaning is conducted following the blast cleaning. For this purpose, the works 6 are already located within the cleaning liquid. Under this condition, vibration of the vibration brushing unit 8 is started (S1401). Subsequently, angle of the vibration brush 8 is set tot +30° (FIG. 9(a)) (S1402). Thereafter, the works 6 are caused to start the reciprocal movement after positioning the vibration brush unit 8 and the works 6 (S1403). Under this condition, the brushing is conducted for a predetermined number of times.

Next, the angle of the vibration brush unit 8 is set to −30° (FIG. 9(b)) (S1404) and the works 6 are caused to conduct the reciprocal movement (S1405) to realize the brushing of the works 6. Thereafter, the angle of the vibration brush unit 8 is set to 0°(FIG. 9(c)) (S1406) and the works 6 is caused to conduct the reciprocal movement to realize the brushing process of the works (S1407).

Thereafter, the vibration brush unit 8 is rotated to rotate the brushing direction 90° (S1408). In this case, the angle of the vibration brush unit 8 is set to 0°. Here, the works 6 are subjected to the reciprocal motion to conduct the brushing of works 6 (S1409). When the brushing processes of the predetermined number of times are completed, vibration of the vibration brush unit 8 is stopped (S1410) and the cleaning process shifts to the pulse spray cleaning (S1411).

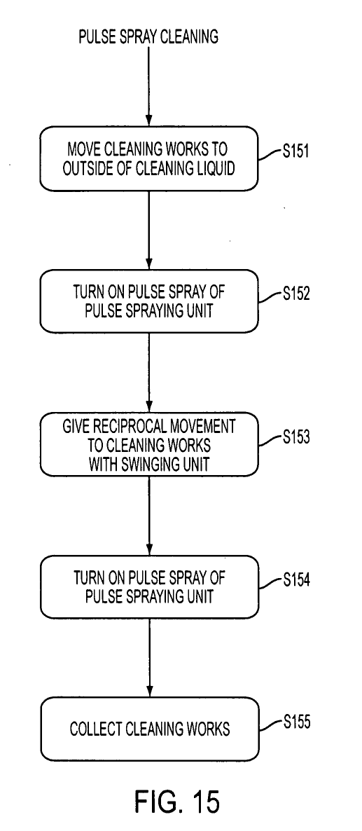

FIG. 15 is a diagram showing procedures of the pulse spray cleaning of the present embodiment.

The works 6 are moved to the external side of the cleaning liquid for conducting the pulse spray cleaning (S151). Subsequently, the pulse spraying unit 9 and the works 6 are located and the pulse spraying unit 9 sprays the cleaning liquid to the works 6 (S152). In this timing, the works 6 are caused to conduct the reciprocal motion to realize the pulse spray cleaning (S153). After the predetermined cleaning operation is completed, spraying of the cleaning liquid from the pulse spraying unit 9 is stopped (S154). The works 6 having completed the pulse spray cleaning are collected as required (S155).

In the cleaning apparatus explained above, only one cleaning vessel is provided and the cleaning mechanism to be used is switched for each cleaning process using the common cleaning vessel. Such a cleaning apparatus is suitable for an application which is less required to conduct the cleaning of a large amount of products within a short period, as the cleaning of products in the small lot. However, when effective cleaning of a large amount of works within a short period of time is required, a plurality of cleaning processes are conducted in parallel by providing a plurality of cleaning vessels in the cleaning apparatus and also providing each cleaning mechanism corresponding to respective cleaning vessels. Moreover, necessity of manual procedures for movement of products between the cleaning vessels may be lowered and effective cleaning work within a short period of time may also be realized.

In the case where a plurality of cleaning vessels are provided in the cleaning apparatus, it will be not required to provide the cleaning vessel to be used for reserving the cleaning liquid for the pulse spraying unit which does not conduct the cleaning in the cleaning liquid. However, it is preferable to provide a receiving tray for receiving the cleaning liquid in order to collect the cleaning liquid sprayed from the pulse spraying unit.

As explained above, according to the cleaning apparatus, cleaning method or product manufacturing method of the present invention, contamination can be removed without resulting in any damage on works as the cleaning objects.

Moreover, according to the present invention, contamination adhered to each surface of a work can be removed effectively by conducting the cleaning of works in combination with a plurality of cleaning mechanisms cleaning methods. Particularly, ESD breakdown of works can be prevented by first cleaning the works within the cleaning liquid, and re-adhesion of contamination to works can also be prevented by finally conducting the cleaning of works by taking the works out of the cleaning liquid.

The present invention can be utilized for removal of contamination by wax and residues of resist on the work and can also be used in various processes without relation to kinds of contamination of works as the cleaning objects.

The present application is not limited to the above-described embodiments, and variations changes and modifications would be obvious to one of ordinary skill in the art. These changes and modifications may be made without departing from the scope of the present invention, and it is intended that the present application encompass such changes and modifications.

What is claimed is:

1. A cleaning apparatus for cleaning objects, comprising:
a cleaning vessel storing liquid; and
a spraying unit spraying cleaning liquid including polishing particles,
wherein said cleaning apparatus locates said objects within the liquid stored in said cleaning vessel during the cleaning of said objects and sprays the cleaning liquid on said objects within said liquid from said spraying unit.

2. The cleaning apparatus as claimed in claim 1, further comprising:
a swinging unit swinging the objects relatively to the spraying unit,
wherein the cleaning apparatus operates to swing the objects with the swinging unit to clean the objects with the spraying unit.

3. The cleaning apparatus according to claim 1, wherein the spraying unit comprises an adjusting unit adjusting a spraying angle of the cleaning liquid relative to the objects.

4. The cleaning apparatus according to claim 2, characterized in that the spraying unit comprises an adjusting unit adjusting a spraying angle of the cleaning liquid relative to the objects.

5. The cleaning apparatus according to claim 1, further comprising a rotating unit rotating the spraying unit along a predetermined plane.

6. The cleaning apparatus according to claim 2, further comprising a rotating unit rotating the spraying unit along a predetermined plane.

7. The cleaning apparatus according to claim 3, further comprising a rotating unit rotating the spraying unit along a predetermined plane.

8. A cleaning apparatus, comprising:
a cleaning vessel storing liquid; and
a brushing unit brushing objects,
wherein said cleaning apparatus locates said objects within the liquid stored in said cleaning vessel during the cleaning of said objects and brushes said objects within said liquid with said brushing unit.

9. The cleaning apparatus according to claim 8, further comprising:
a swinging unit swinging the cleaning objects relative to the brush unit,
wherein the cleaning apparatus swings the objects with the swinging unit to clean the objects with the brushing unit.

10. The cleaning apparatus according to claim 8, wherein the brush unit comprises an adjusting unit adjusting a contact angle relative to the objects within a predetermined range.

11. The cleaning apparatus according to claim 9, wherein the brush unit comprises an adjusting unit adjusting a contact angle relative to the objects within a predetermined range.

12. The cleaning apparatus according to claim 8, further comprising a rotating unit rotating the brush unit along a predetermined plane.

13. The cleaning apparatus according to claim 9, further comprising a rotating unit rotating the brush unit along a predetermined plane.

14. The cleaning apparatus according to claim 10, further comprising a rotating unit rotating the brush unit along a predetermined plane.

15. A cleaning apparatus, comprising:
a cleaning vessel storing liquid;
a holding mechanism moving objects into said cleaning vessel;
a first cleaning mechanism conducting a first cleaning process requiring mechanical contact with said objects; and
a second cleaning mechanism conducting a second cleaning process of spraying cleaning liquid on said objects,
wherein said cleaning apparatus cleans said objects with said second cleaning mechanism outside of said cleaning vessel after cleaning said objects with said first cleaning mechanism within said cleaning vessel.

16. The cleaning apparatus according to claim 15, wherein the first cleaning mechanism uses a brush unit.

17. The cleaning apparatus according to claim 16, further comprising a swinging unit swinging the brush unit.

18. The cleaning apparatus according to claim 16, further comprising a mechanism for sound-vibrating the brush unit.

19. The cleaning apparatus according to claim 16, further comprising a mechanism for changing an angle of the brush unit relative to the objects.

20. The cleaning apparatus according to claim 16, wherein the brush unit is constituted by a brush formed of a conductive material.

21. A product manufacturing method, comprising:
conducting pre-processing of objects;
moving said objects into a cleaning vessel storing cleaning liquid;
spraying said cleaning liquid including a polishing particle on said objects within said cleaning liquid;
taking said objects out of said cleaning liquid; and
conducting post-processing of said objects having completed the cleaning process.

22. A product manufacturing method, comprising:
conducting pre-processing of a objects;
moving said objects into a cleaning vessel storing cleaning liquid;
brushing said objects within said cleaning liquid using a brush;
taking said objects out of said cleaning liquid; and
conducting post-processing of said objects having completed said cleaning process.

23. A product manufacturing method, comprising:
conducting pre-processing of objects;
cleaning said objects within a cleaning liquid;
taking said objects out of said cleaning liquid;
spraying said cleaning liquid on said objects; and
conducting post-processing of said objects.

24. A cleaning method, comprising:
locating objects within cleaning liquid;
spraying a polishing particle on said objects within said cleaning liquid;
brushing said objects within said cleaning liquid after said polishing particle spraying process;
taking out said brushed objects from said cleaning liquid; and
spraying said cleaning liquid on said objects taken out from said cleaning liquid.

25. The cleaning method according to claim 24, wherein in the spraying the polishing particle, the polishing particle is mixed with the cleaning liquid and is then sprayed to the objects.

26. The cleaning method according to claim 24, wherein the brushing is performed by a sound-vibrated brush.

27. The cleaning method according to claim 26, wherein the brush is vibrated in a predetermined direction.

28. The cleaning method according to claim 24, further comprising:
applying ultrasonic waves to the cleaning liquid in the spraying said cleaning liquid.

29. A product manufacturing method including cleaning objects, comprising:
soaking said objects in cleaning liquid; and
cleaning said objects with mechanical contact to said objects within said cleaning liquid.

30. The product manufacturing method according to claim 29, wherein the cleaning liquid is mixed with a polishing particle.

31. The product manufacturing method according to claim 29, wherein the cleaning is performed using a brushing process.

32. A product manufacturing method including cleaning objects, comprising:
soaking said objects in cleaning liquid;
cleaning said objects with a first cleaning method within said cleaning liquid;
taking said objects out of said cleaning liquid; and
cleaning said objects with a second cleaning method different from said first cleaning method.

33. A cleaning apparatus for objects, comprising:
a moving unit moving said objects;
a first cleaning unit spraying cleaning liquid including a polishing particle on said objects within said cleaning liquid;
a second cleaning unit brushing said objects within said cleaning liquid; and
a third cleaning unit spraying said cleaning liquid on said objects outside of said cleaning liquid,
wherein said cleaning apparatus cleans said objects in the sequence of cleaning by said first cleaning unit, said second cleaning unit and then said third cleaning unit.
